(19) United States
(12) Patent Application Publication
(10) Pub. No.: US 2011/0203113 A1
(43) Pub. Date: Aug. 25, 2011

(54) Razor Cartridge With Improved Cap Structure

(76) Inventor: Xiandong Wang, Acton, MA (US)

(21) Appl. No.: 12/712,542

(22) Filed: Feb. 25, 2010

(51) Int. Cl. B26B 21/40; B26B 21/14; B21K 11/00

(52) U.S. Cl. 30/41; 30/50; 30/84; 76/104.1

(57) ABSTRACT

A razor cartridge having blades and a cap structure in back of the blades where the cap structure extending across the length of the blades includes at least one skin engaging element and at least one shaving aid portion. The skin engaging element may comprise fin elements, elongated protrusions, bumps, nubs, or any combination thereof, and may be flexible to engage the user's skin in back of the blades for a comfortable shave. The shaving aid portion serves to deliver at least one shaving aid material (e.g., lubricant) to the skin. The shaving aid portion may be a lubricating strip, a soap/solid, a foam or sponge filled with shaving aid material or any combination thereof. The cap structure provides a synergy between the skin engaging element and the shaving aid portion. A percentage contact to a user's skin of the skin engaging element is from about 20% to about 90%.

### FIELD OF THE INVENTION

This invention relates to razor blades, and more particularly to an improved cap structure.

### BACKGROUND OF THE INVENTION

A wet shave razor cartridge is usually composed of a cartridge housing, blades having cutting edges, a guard area in front of the blades and a cap area having a shaving aid or lubricating strip (e.g., most commonly referred to as a lubrastrip) disposed behind the blades. Each component plays a unique role during shaving.

As known in the art, a shaving aid or lubrastrip, which may generally be a polyethylene oxide and polystyrene (PEO/PS) based chemical delivery component, is most often used to improve the shaving performance. The lubrication provided by the lubrastrip is important in terms of providing a smooth glide, lowering the razor drag and achieving a more comfortable shave, a rather well-perceived benefit for consumers.

Most lubrastrips on the market today have a firm, hard body and upper surface when compared to a user's skin which is generally soft and supple. With the ever-increasing sharpness of razor blade edges in razor products, such hardness may provide more discomfort to the consumers since the surface of lubrastrip may become increasingly slippery when wet, in turn, unable to hold skin back for optimal skin management during shaving.

Having a soft, less slippery material in the cap structure or lubrastrip area that will also achieve a comfortable, close shave when used with sharp blade edges may thus be desirable.

It is generally known in the art that elastomeric fin guards, placed in the front of the razor blades, are made of a soft material. This type of fin guard generally has flexible fins or protrusions that play an important role for the engagement, alignment, and extension of hair while also managing the skin during shaving. Some of these types of benefits found in the fin guard were extended to the cap portion as described, for instance, in U.S. Pat. Nos. 5,191,712 and 5,416,973 where elastomeric fin elements are disposed in either a parallel or perpendicular orientation to the blade edges in an attempt to exhibit lower friction and provide a more comfortable shave.

There is still, however, a need in the art to improve the cap structure of the razor cartridge to provide more enhanced performance in terms of skin management, comfort, efficiency and safety.

### SUMMARY OF THE INVENTION

The invention provides an apparatus for a razor cartridge including one or more blades, each of the blades having a cutting edge and a cap structure, disposed behind the blades and extending across a length of the cutting edges, where the cap structure includes at least one skin engaging element and at least one shaving aid portion.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a top view of a razor cartridge showing a cap structure having a shaving aid portion in back of skin engaging elements in accordance with the present invention.

FIG. 2 is a side view of the cap structure of FIG. 1.

FIG. 3 is a top view of a razor cartridge showing a cap structure having a shaving aid portion in front of skin engaging elements in accordance with the present invention.

FIG. 4 is a top view of a razor cartridge showing a cap structure having a shaving aid portion in the middle of skin engaging elements in accordance with the present invention.

FIG. 5 is a top view of a razor cartridge showing a cap structure having two shaving aid portions in back of skin engaging elements in accordance with the present invention.

FIG. 6 is a top view of a razor cartridge showing a cap structure having two shaving aid portions in front of skin engaging elements in accordance with the present invention.

FIG. 7 is a top view of a razor cartridge showing a cap structure having two shaving aid portions in the middle of skin engaging elements in accordance with the present invention.

FIG. 8 is a top view of a razor cartridge showing a cap structure having two shaving aid portions in back of skin engaging elements in accordance with another embodiment of the present invention.

FIG. 9 is a top view of a razor cartridge showing a cap structure having two shaving aid portions, one in back of the skin engaging elements and one in front of the skin engaging elements in accordance with another embodiment of the present invention.

FIG. 10 is a top view of a razor cartridge showing a cap structure having two shaving aid portions, one around the periphery of the skin engaging elements and one in front of the skin engaging elements in accordance with yet another embodiment of the present invention.

FIG. 11 is a top view of a razor cartridge showing a cap structure having three shaving aid portions in back of skin engaging elements in accordance with the present invention.

FIG. 12 is a top view of a razor cartridge showing a cap structure having non-contiguous skin engaging elements with shaving aid portion disposed therein in accordance with the present invention.

FIG. 13 is a top view of a razor cartridge showing a cap structure having a wavy skin engaging element and a wavy shaving aid portion in accordance with the present invention.

FIG. 14 is a side view of a skin engaging element having fin elements with non-planar upper surfaces in accordance with the present invention.

FIG. 14A through FIG. 14E are alternate embodiments of fin elements on the skin engaging element of the present invention.

FIG. 15 depicts a razor cartridge showing a cap structure having one skin engaging element with elongated protrusions and a shaving aid portion in accordance with the present invention.

FIG. 16 depicts a razor cartridge including a trimmer blade having a cap structure with a shaving aid portion in back of skin engaging elements in accordance with the present invention.

### DETAILED DESCRIPTION OF THE INVENTION

Choosing materials, properties and configurations for an appropriate cap structure (e.g., generally defined as the area behind the blades), leveraging the synergistic effect between the cap structure and the blades, may be desirable to providing improved shaving attributes, such as consistent shave closeness, comfort, less irritation, more safe, and tactile benefit during wet shaving.

This invention relates to a novel “cap structure” in a razor for wet shaving where the cap structure disposed in an area generally directly behind the blades in the rear of a razor includes at least one skin engaging element and at least one shaving aid portion having at least one shaving aid material. The skin engaging element is desirably made of an elastomeric material and includes a flexible fin(s) or protrusions. The shaving aid portion may be arranged in any location with respect to the skin engaging element. When using more than one shaving aid portion or more than one skin engaging element, each portion may be arranged in any manner or location with respect to each other portion. As a result, the novel cap structure provides consumers with a pleasant, tactile sensation and a consistent, comfortable and close shave.

In the present invention, certain germane terms are defined as follows:

The term “skin engaging element” signifies a physical structure which engages, holds, or stretches a user's skin for skin management during shaving and may be of any type including, but not limited to, one or more fin elements, elongated filaments or protrusions, or nubs. The skin engaging element may be upstanding or curved, flexible or rigid, may have planar or non-planar surfaces, may be contiguous, non-contiguous, patterned, or any combination thereof. A skin engaging element may be made of any type of material such as, but not limited to, elastomers, rubbers or other polymers. Elastomers such as silicone, fluorosilicone, polyisoprene, polybutadiene, polyisobutylene, copolymers such as styrene-ethylene-butylene-styrene (SEBS) based thermoplastic elastomer, styrene-ethylene-propylene-styrene (SEPS) based thermoplastic elastomer, polyoxyethylene-polyurethane based elastomer, or rubbers such as acrylonitrile-butadiene, polyacrylate and natural rubber, or other polymers such as polyurethane, polystyrene and polyethylene, or any combination thereof are also contemplated in the present invention. Additionally, the skin engaging element material may include modifications of one or more of the above-listed materials (e.g., polymers and rubbers and their composites) with other materials. Finally, the materials may include textile or fabric materials, natural materials (e.g., wood), or metals coated with elastomeric or plastic materials.

As will be described below, the skin engaging element of the present invention desirably utilizes effective skin management elastomers and an arrangement of fin elements (e.g., in a preferred embodiment, perpendicular to the shave direction) which together increases friction with a user's skin to better affect skin management, and a well-controlled cap structure geometry to achieve the maximum synergy, in particular with low cutting force or sharp edges. As will be discussed below, both the structure of the skin engaging element (as an important part of cap structure) and the geometry of the skin engaging element play an important role in the present invention.

The term “shaving aid portion” represents a physical structure capable of having or having a “shaving aid material” disposed therein. In the present invention, the shaving aid portion may include but is not limited to, a lubricating strip (e.g., lubrastrip), a soap body, or a foam body having a shaving aid material disposed therein (e.g., impregnated or otherwise embedded in pores or voids), or any combination thereof. The lubrastrip generally continuously releases a shaving aid material (defined below), typically a lubricant, during the shaving process. For instance, examples of lubrastrips are described in U.S. Pat. No. 4,170,821, entitled “Razor Cartridges” issued on Oct. 16, 1979, U.S. Pat. No. 5,113,585 entitled “Shaving System” issued on May 19, 1992 describing a composite including a water-insoluble matrix material, a water-soluble shaving aid, and a low molecular weight release enhancing agent, and U.S. Pat. No. 6,442,839, entitled “Shaving System” issued on Sep. 3, 2002, describing a co-extruded lubricating composite with two portions, each with a different formulated shaving aid, the aforementioned assigned to the Assignee hereof.

As known in the razor arts, a lubrastrip generally comprises a water-insoluble polymer matrix, typically polystyrene, and a water-soluble shaving aid, typically polyethylene oxide, which leaches out of the lubrastrip during shaving to enhance shave comfort.

The foam may be a basic foam or sponge or a gradient foam of the type disclosed in U.S. patent application Ser. No. 12/350,286 entitled “Fluid Delivery System” and in U.S. patent application Ser. No. 12/350,446 entitled “Hair Removal with Fluid Delivery” assigned to the Assignee hereof.

The term “shaving aid material” signifies any composition for use with skin or hair. Such compositions may include, but are not limited to, lubricious agents such as a hydrophilic polymer (e.g., polyethylene oxide/polystyrene or PEO/PS), or agents for depilation, cleaning, cooling, inhibiting or enhancing the growth of hair, inhibiting the growth of microbes, inhibiting drag, inhibiting wrinkles, moisturizing, improving skin tone or condition, medicinal purposes, or any combination thereof. Agents may include, but are not limited to, ingredients such as aloe, vitamin E, lanolin, perfumes, or glycolic acids.

It should be noted that the term “cap structure” of the present invention generally refers to an area, behind, but proximal to the blades, substantially contacting the skin during the entire course of shaving, and supporting the substantial load applied to the rear portion of cartridge during shaving. Thus, to aptly contact the skin, the shaving aid portion and skin engaging element may necessarily need to be arranged to encompass a substantial portion of a central or middle area of the cap structure behind the blades. This central portion may desirably extend across the length of the blades. Percentage contact to the skin by each element will be described in more detail below, but in general, by having both at least one skin engaging element and at least one shaving aid portion in this area, the functionality of the cap structure is maximized and some unforeseen advantages over the prior art are realized.

For instance, having a combination of a skin engaging element and a shaving aid portion will allow the cap structure to provide both a significant skin management contribution from the skin engaging element, achieving notable improvements in shaving attributes such as closeness, even for very sharp (e.g., low cutting force edged) blades, while at the same time also providing an appropriate lubrication which reduces shaving tug and pull for smoother and more comfortable shave.

By being disposed together (e.g., within cap structure) in the cap area as will be described in detail below, the skin engaging element and the shaving aid portion will thus necessarily share and balance the applied normal load to the cap structure during the shave, whereas with only one or the other of skin engaging element or shaving aid portion, this load is not shared.

The sharing of the load is unexpectedly beneficial, since each element in the cap structure does not have to, by itself, account for the cap geometry. The cap geometry may generally be determinative of “cap exposure”, the latter being the relative height difference between the top surface of the cap structure and the blade edge plane. These concepts are described in detail in pending U.S. patent application Ser. No. 12/174,317, entitled “Shaving Aid Geometry For Wet Shave System”, assigned to the assignee hereof.

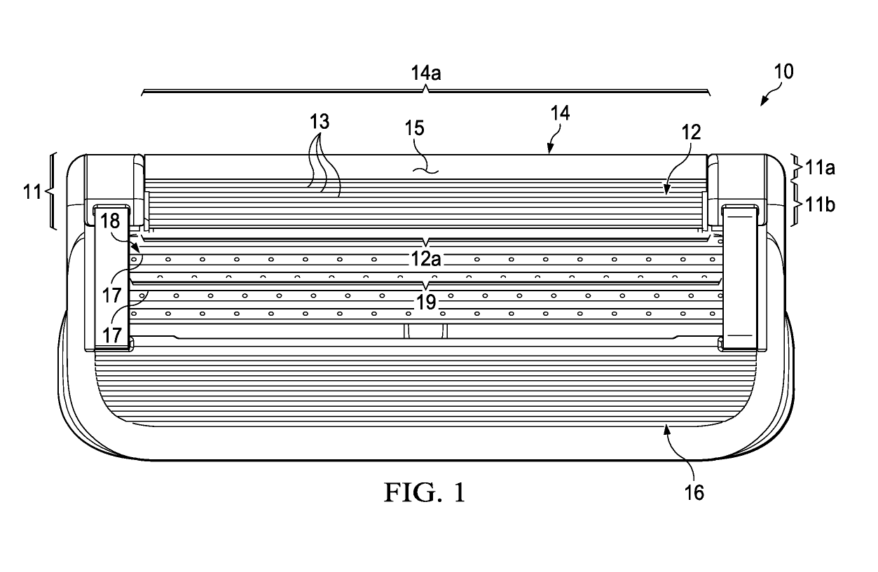

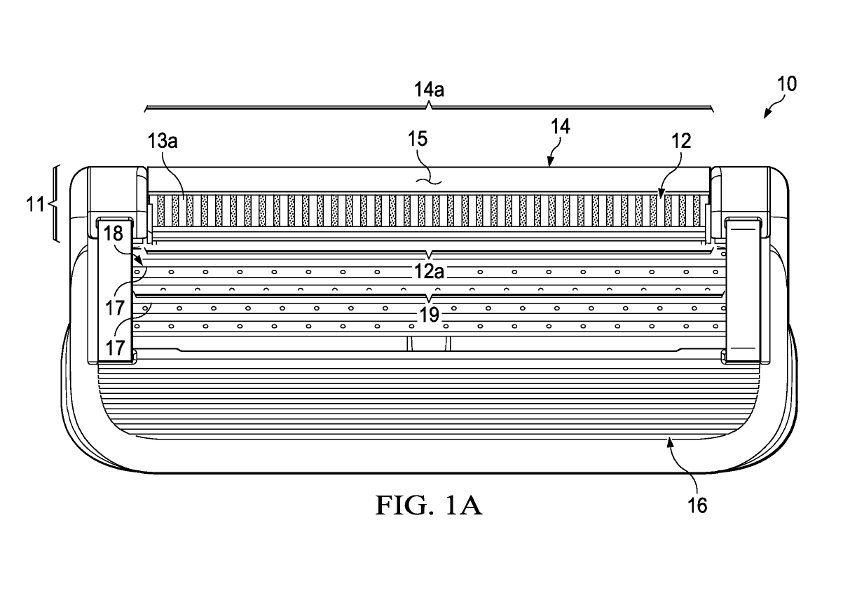

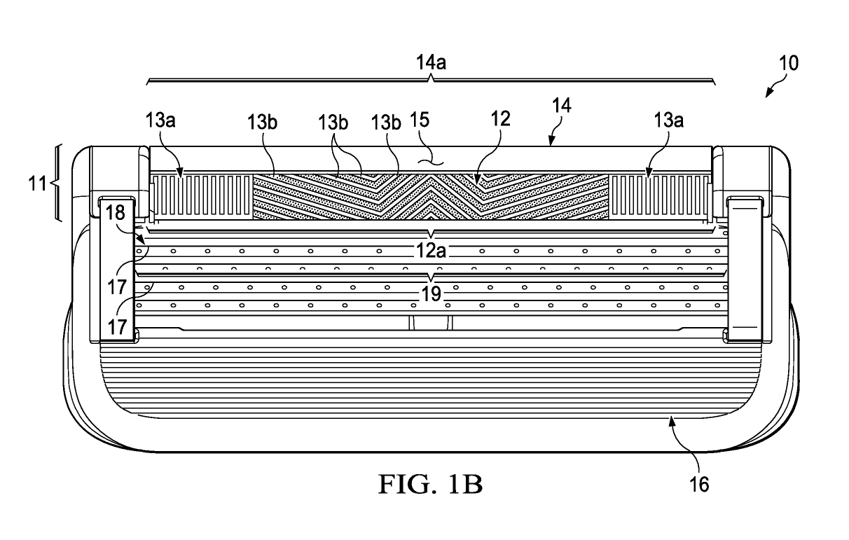

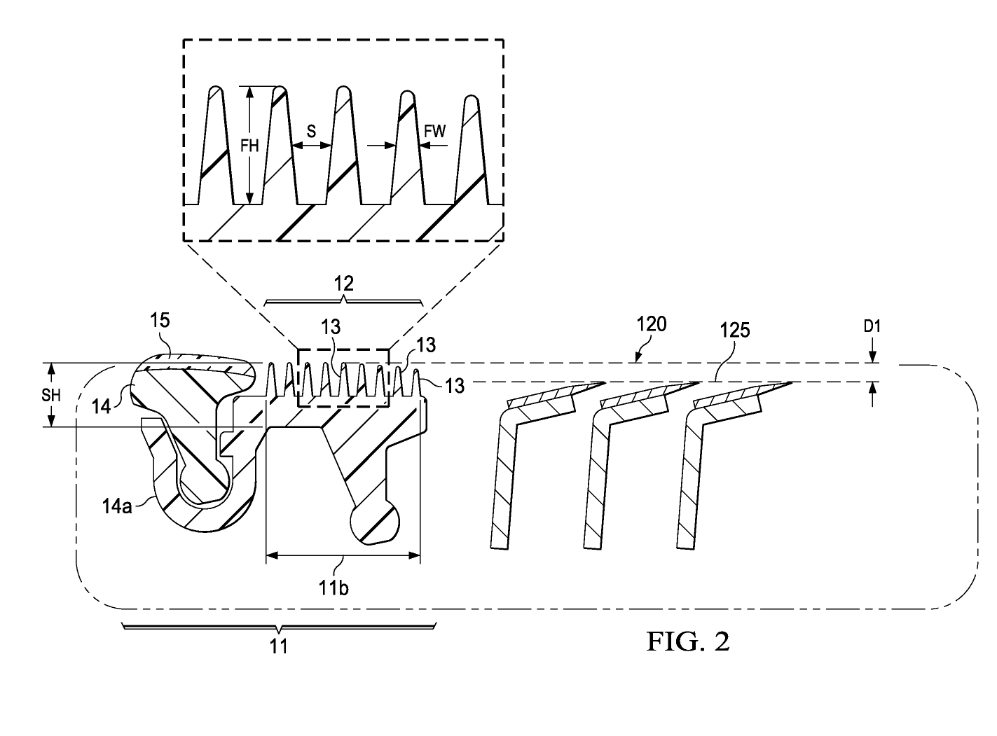

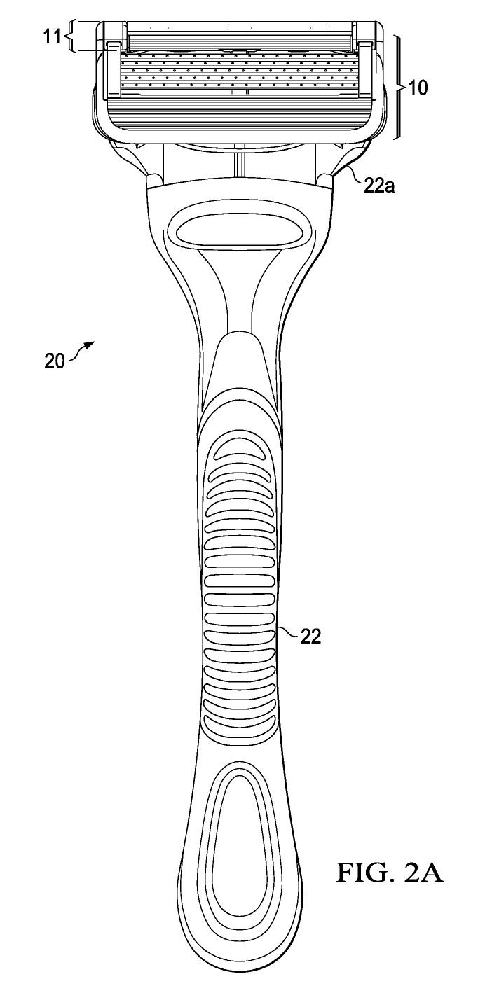

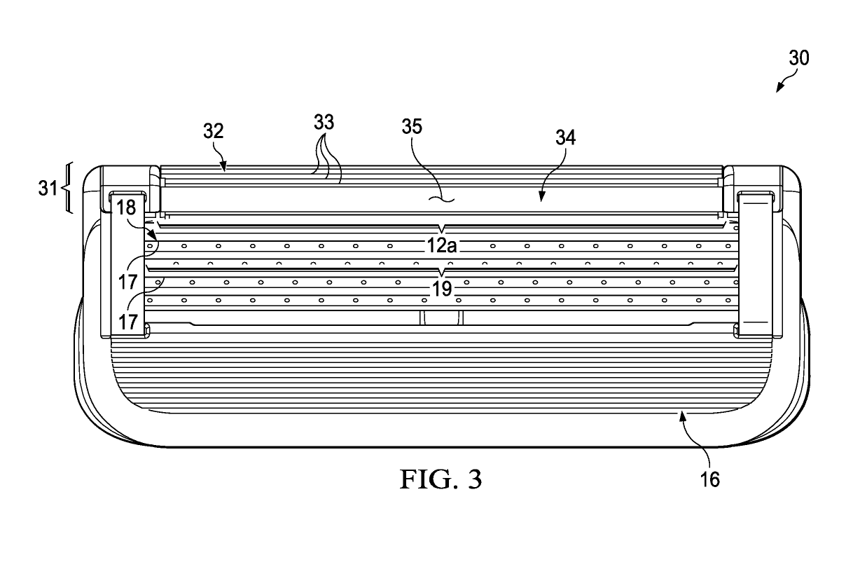

Generally, however, if the skin engaging element 12 is closer to the blades than the shaving aid portion 14, referring to the embodiment of FIG. 1, the cap exposure may be defined as the height difference D1 of about the middle of the skin engaging element or for instance, a height D1 taken at a middle fin 13b in the skin engaging element 12 relative to the blade plane 125 as shown in FIG. 2. Similarly, if the shaving aid portion 14 is closer to the blades than the skin engaging element 12 (referring to the embodiment of FIG. 3), the cap exposure may be defined as the height difference (not shown) of the shaving aid portion 34 relative to the blade plane 125.

Having a noticeable positive cap exposure, (e.g., where a cap structure is higher than the blade plane), may generally result in losing some shaving closeness, whereas a significant negative cap exposure, i.e., cap is lower than the blade plane, may generally cause irritation, or nicks and cuts during shaving. Desirably, the cap exposure may be neutral or slightly positive as shown by height difference D1 in FIG. 2. For instance, the cap exposure may range from about −0.10 mm to about 0.20 mm, and preferably range from about 0.05 mm to about 0.10 mm in the present invention, where in addition, naturally the cap exposure may depend on the stiffness and flexibility of each fin element 13 and the yielding ability or deforming nature of the entire skin engaging element 12.

The novel cap structure of the present invention may conceivably provide a dynamic regime; one in which the cap structure geometry may vary within a small range during each stroke and the magnitude of cap exposure variation may depend on the pressure that is applied to the cap structure, the friction between the cap structure and a user's skin surface, the type of shaving aid portion as well as the elasticity of the fin elements. For instance, if cap exposure is positive, a user or shaver will naturally adjust the pressure to achieve the best closeness. However, if the cap exposure is negative (relative to blade plane), the shaver will likely decrease the pressure applied to cartridge. With the dynamic nature innate to the novel cap structure, a user may desirably achieve their best shave without having to intentionally adjust the shaving pressure.

The present invention may allow the skin engaging element which is generally soft, when disposed in the cap structure with a shaving aid portion, to not become as significantly compressed and/or deformed as prior art skin engaging elements (e.g., the sole element in the cap structure), and therefore the cap geometry is basically maintained within a minimum variation during a wet shave and conceivably for many shaves longer than the prior art. And, in conjunction, while the shaving aid portion can still deliver the appropriate amount of lubrication and other skin beneficial ingredients, it advantageously may wear at a slower rate when disposed together with a skin engaging element as in the present invention rather than if it were the sole element in the cap structure, as found in many prior art razors.

Furthermore, in addition to wearing at a slower rate and potentially using less shaving aid material, by not having to also solely account for cap geometry anymore, the shaving aid portion of the present invention has the advantage of potentially accommodating more skin beneficial chemical ingredients. Assuming cap geometry in the present invention will not dominantly depend on the shaving aid portion, this may desirably take off the heavy burden of mechanical requirements, such as hardness and mechanical integrity, for the traditional shaving aid like lubrastrip. Thus, the traditionally used polymer matrix material for lubrastrips, such as polystyrene with high melting point may be desirably replaced by new polymer matrix materials, such as ethylene vinyl acetate (EVA), polycaprolactone (PCL) to name a few, which have lower melting points. Therefore, the shaving aid portion of the present invention may generally be processed at much lower temperatures than those disclosed in the prior art (which are roughly about 180° C.), allowing for the accommodation of other new or desired chemical ingredients, not previously capable of being considered, as they may not generally have been thermally stable at the prior art temperature of about 180° C. These ingredients may further provide additional attributes to the shaving aid portion in turn discerned by a user.

Further, the present invention provides great flexibility in balancing both skin engaging elements and lubrication elements which may appeal to different categories or demographics of consumers; for instance, by providing various options of cap structures, the ability for a consumer to potentially choose between different configurations is afforded. For instance, configurations may change the relative amounts of the skin engaging element vis-à-vis the shaving aid portion, or may change their relative geometry or arrangement.

Additionally, the razor cartridge of the present invention may be relatively easy to clean as it compares to sole lubrastrip of the prior art as for instance, a sole lubrastrip, which is generally very close to the last blade, once it has been wetted, swelled and released of lubricant, the lubricant may expand to or cross over to the most proximal blade and/or other blades and then be difficult to remove from the blade edges, in particular after it dries, which in turn may require more water to clean off the lubricant for subsequent shaves.

Various embodiments of the present invention highlighting these advantages are further described below.

Referring now to FIG. 1, a razor cartridge 10 showing a cap structure 11 having skin engaging element 12 and a shaving aid portion 14 disposed behind the skin engaging element 12 in accordance with the present invention is provided. The present invention contemplates having one or more razor blades 18 disposed in cartridge 10. FIG. 1 shows five (5) razor blades 18, each having respective cutting edges 17.

The present invention contemplates having at least one skin engaging element 12 with one or more fin elements 13. Skin engaging element 12 is shown in FIG. 1 as having nine (9) fin elements 13. Advantageously, any number of skin engaging elements or fin elements as desirable may be disposed in the cap structure to affect an improved shave in the present invention. Fin elements 13 may be similar in construction to fin elements typically found in guard components such as guard 16.

As shown in FIG. 1, the skin engaging element 12 or fin elements 13 extend a length 12a along a parallel axis to the cutting edges 17 of the plurality of blades 18 and across a substantial portion of the blade length 19. The skin engaging element 12 of FIG. 1 may be disposed generally across the length of the top of the cartridge or the length of the cutting edges (blade length 19) behind blades 18 in a contiguous manner, having no gaps or openings in the fin elements. The element 12 or fin elements 13 however, may be arranged in a non-contiguous or other fashion as will be described in more detail below.

The skin engaging element structure of the present invention comprises an overall width 11b (as shown in FIGS. 1 and 2) ranging from about 0.5 mm to about 5.0 mm and more desirably about 1.5 mm to about 2 mm, an overall length 12a (as shown in FIG. 1) of about 32 mm, and a skin engaging element thickness or height SH (as shown in FIG. 2) ranging from about 0.4 mm to about 2.5 mm. The thickness SH and other skin engaging element dimensions may vary depending on design.

As also shown in FIG. 2, the width FW of a fin element 13 if present in the skin engaging element of the present invention may desirably range from about 0.1 mm to about 0.25 mm, and preferably about 0.15 mm, the space S between adjacent fins may desirably range from about 0.1 mm to about 0.2 mm, and more desirably about 0.15 mm and the height FH of each individual fin element 13 may desirably range from about 0.2 mm to about 2.0 mm and more desirably range from about 0.4 mm to about 1.0 mm.

It should be noted that one may assume a contact area for the whole of cap structure 11 with a user's skin surface as being substantially about 100%. Thus, with a cap structure comprised of both a skin engaging element and a shaving aid portion, both contact the skin so that a sum total of skin contact is about 100%.

In the prior art, generally the percentage skin contact of the skin engaging element to the skin is generally substantially near 100% as found in U.S. Pat. No. 5,191,712, entitled “Safety Razors and Guards” issued on Mar. 9, 1993 where a cap area includes only fin elements with no lubricating strip, or generally a percentage skin contact of less than 10% as found in U.S. Patent Publication No. 2005/0188539, entitled “Shaving Blade Unit” published on Sep. 1, 2005 where a cap area depicts small fin elements in the corners.

However, it has been generally determined that the greater the length of the skin engaging element or the broader the surface area or coverage provided by the skin engaging element on a user's skin, the more the user can appreciate a soft, comfortable, and close shave. Thus, in contrast, in the present invention, it is desirable to have a percentage of contact to the skin for the skin engaging element portion of the cap structure be in the range of about 20% to about 90%, more desirably from about 35% to about 65%, and most desirably about 50%. Thus, in a cap structure having both a skin engaging element and a shaving aid portion, this may generally necessitate the length of a skin engaging element to be greater than about 50% of the blade length 19 up to about the length of the blade length 19, regardless of the type of skin engaging element (e.g., non-contiguous, contiguous, fin elements, or protrusions).

In this way, the percentage skin contact from cap structure 11 is effectively shared between the skin engaging element and the shaving aid portion, neither element of the cap structure providing full 100% contact with the skin and with the skin engaging element providing about 20% to about 90%, and advantageously about 35% to about 65%, more desirably about 50% of that percentage contact while also desirably more than 75% of that percentage contact.

Shaving aid portion 14, as illustrated in FIG. 1, is a lubricating strip (e.g., lubrastrip) 14 which may dispense a shaving aid material 15 of any type (e.g., as described above) during shaving. Though a lubricating strip generally is known to have a relatively hard contact surface which becomes very slippery when wet, as portion 14 it is intended to be used in conjunction with at least one skin engaging element 12 which aptly holds back or manages the skin. Thus, despite the hard, slippery surface of the lubricating strip, skin engaging element 12 effectively makes the lubricating strip less slippery, providing a user of the novel cap structure 11 with a more comfortable and close shave over that of the prior art. This may generally due to the user having a much improved sensation of a soft material touching or gliding on their skin during shaving when using a cartridge having the cap structure of the present invention. In addition, the added comfort provided by the cap structure 11 of the present invention may allow for different blade types to be chosen or other arrangements designed (e.g., sharper blades) which may otherwise not be feasible.

As depicted in FIG. 1, the length 14a of the shaving aid portion 14 may desirably be about the same as length 12a of skin engaging element 12. The present invention contemplates that the length 14a may be any length but more desirably may be at least about 50% or more of the blade length 19 regardless of the type of shaving aid portion or material and the width 11a of a shaving aid portion in the present invention may be in the range of 0.5 mm to about 5 mm, desirably about 1 mm to about 2 mm and more typically about 3 mm.

In addition to providing lubricity, moisture, etc. at the back end of the razor cartridge 10, the shaving aid portion 14 may also serve as a wear indicator denoting to a user a time to change the razor cartridge (e.g., as material 15 is used up or expended).

A large skin engaging element in the cap structure as depicted in FIG. 1 (e.g., extending across up to about the length of the blades) substantially contacts the skin and thus also assists in wiping out any shave prep applied to the skin by a user and additionally may trap small amounts of this shave prep within its fin elements, releasing it in subsequent strokes. Thus, there may conceivably be an added synergy, not previously available in the prior art, between the present invention cap structure and shave preparation formulations (“shave prep”) applied by a user to a skin area to be shaved.

For instance, using the embodiment of FIG. 1 for shaving, after a first stroke, the skin engaging element of the cap structure initially serves to trap the applied shave prep, while for subsequent strokes, the skin engaging element may likely trap additional deposited shave prep or/and shaving aid material while also releasing old trapped prep/aid. This trapping-releasing-trapping-releasing synergistic process will generally be repeated stroke after stroke. In addition, the shaving aid portion of the cap structure of FIG. 1 will secondarily serve to deposit a thin layer of lubricant on the skin which will reduce blade tug/pull etc as each subsequent stroke is completed.

In accordance with the invention, the fin elements 13 may also extend perpendicular to the cutting edges of the blades, at angles, or in any combination thereof, as shown for instance, by elements 12a and 12b in FIGS. 1A and 1B, respectively. These orientations may theoretically reduce the friction force and the drag force to the razor cartridge, as well as providing localized stretching of the skin.

Referring now to FIG. 2, a side view of the cap structure 11 of FIG. 1 is provided showing shaving aid portion 14, including shaving aid material 15, adjacent to skin engaging element 12 having fin elements 13. As shown, the shaving aid portion 14 and the skin engaging element 12 each represent about 50% of the width of the cap structure 11. Thus, the percentage contact to the skin surface 120 from the cap structure originating from the skin engaging element 12 for instance, should theoretically be about 50%. The skin engaging element 12 and the support 14a for shaving aid portion 14 are each desirably manufacturing via injection molding, which may advantageously be thermally adhered to a plastic substrate of a cartridge housing (not shown). The shaving aid portion 14 may either be extruded and snapped into its housing support 14a, or molded into the housing support. It should be noted that other possible manufacturing techniques known in the razor arts are also contemplated in the present invention.

FIG. 3 depicts razor cartridge 30 showing a cap structure 31 having skin engaging element 32 and a shaving aid portion 34 disposed in front of the skin engaging element 32 in accordance with an alternate embodiment of the present invention. Shaving aid portion 34 desirably includes a shaving aid material 35. FIG. 3 has five (5) fin elements 33 similar to those described above in FIG. 1 and as with FIG. 1, FIG. 3 shows five (5) razor blades 18, each having respective cutting edges 17.

The advantages of having shaving aid portion 34 disposed in front of skin engaging element 32 may be to reduce the drag force of cartridge 30 on the skin and conceivably substantially increase the synergy between shaving aid portion 34 and skin engaging element 32 as may be compared with the cap structure 11 in FIG. 1. This synergy may be realized or enhanced by the trapping of the shaving aid material 35 (e.g., a lubricant material) that is released by shaving aid portion 34 within the fins 33 of skin engaging element 32. Thus, conceivably, during subsequent shaves, this trapped or additional shaving aid material may be released and delivered to the skin surface more uniformly.

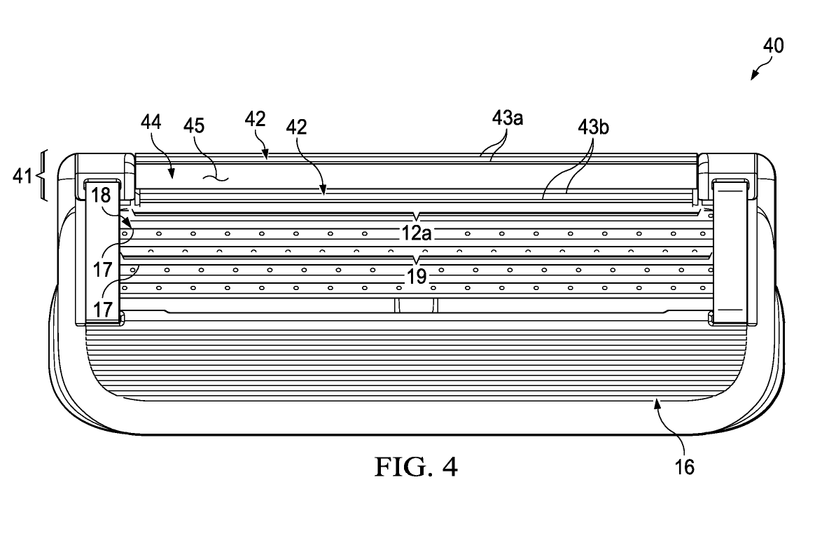

FIG. 4 depicts razor cartridge 40 showing a cap structure 41 having skin engaging element 42 and a shaving aid portion 44 disposed in the middle of the skin engaging element 42 in accordance with another alternate embodiment of the present invention. Shaving aid portion 44 desirably includes a shaving aid material 45. FIG. 4 has a skin engaging element 42 having an upper section of two (2) fin elements 43a disposed above shaving aid portion 44, and a lower section of three (3) fin elements 43b disposed below shaving aid portion 44 and both upper and lower sections are similar to those described above in FIG. 1. Any number of fin elements may be included in the upper section 43a and any number of fin elements may be included in the lower section 43b of skin engaging elements. Furthermore, the present invention contemplates having different types of skin engaging elements disposed in the cap structure 41. For instance, the upper section 43a may include elongated protrusions or nubs (not shown) whereas the lower section may include fin elements as shown.

As with FIG. 1, FIG. 4 shows five (5) razor blades 18, each having respective cutting edges 17. The advantages of having shaving aid portion 44 disposed in the middle of skin engaging element 42 may be to reduce the drag force of cartridge 40 and conceivably moderately increase the synergy between shaving aid portion 44 and upper section of fin elements 43a as compared with the cap structure 11 in FIG. 1. As with FIG. 3, this synergy may be realized or enhanced by the trapping of the shaving aid material 45 (e.g., a lubricant material) that is released by shaving aid portion 44 within the upper section of fin elements 43a of skin engaging element 42. Thus, conceivably, during subsequent shaves, this trapped or additional shaving aid material may be released and delivered to the skin surface more uniformly. Additionally, lower section 43b of fin elements may conceivably assist in controlling the geometry of the skin and hair being most proximal to the blades.

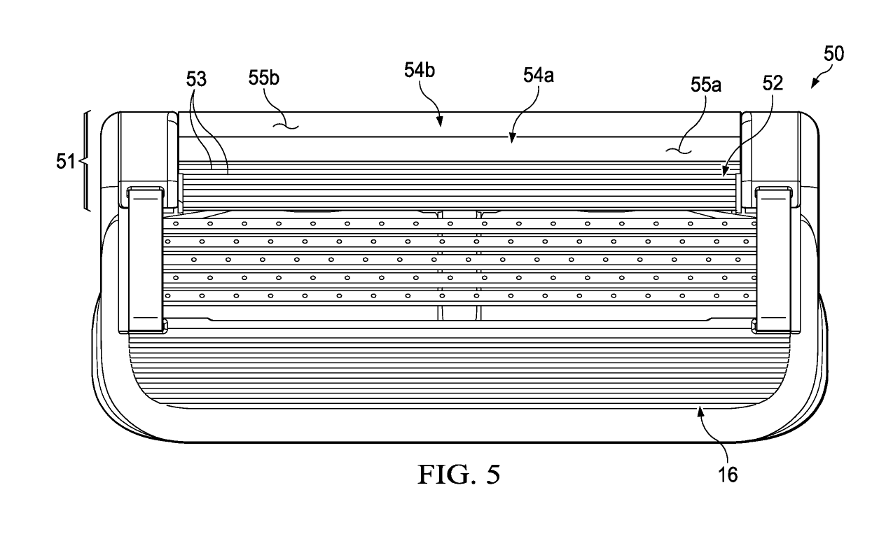

FIG. 5 depicts a razor cartridge 50 showing a cap structure 51 having two shaving aid portions 54a and 54b disposed in back of skin engaging element 52 in accordance with the present invention. Skin engaging element 52 desirably comprises fin elements 53. Shaving aid portions 54a and 54b may be of any type. For instance, shaving aid portion 54a may desirably include a lubricating strip having shaving aid material 55a while shaving aid portion 54b may ostensibly be a soap material (e.g., a soap wing) or foam filled with a shaving aid material 55b. Shaving aid materials 55a and 55b may of any type (e.g., as described above). For instance, shaving aid material 55a may desirably be a PEO/PS while material 55b may desirably comprise moisturizing and cleaning agents as found in soap products.

The thickness of skin engaging element 52 may range from about 1 mm to about 5 mm and the thickness of each shaving aid portion 54a or 54b may range from about 0.5 mm to about 2 mm; thus the thickness of cap structure 51 may range from about 2 mm to about 10 mm.

The advantages of having two shaving aid portions 54a and 54b disposed in back of skin engaging element 52 are the impactful improvements in comfort and closeness sensed by the user while shaving.

Furthermore, one shaving aid material 55a may desirably interact, complement or supplement the other shaving aid material 55b during shaving. An interaction of shaving aid materials may beneficially provide additional real-time, sensory, skin or hair condition improvements ostensibly not obtainable with an arrangement of one shaving aid portion having one shaving aid material. Even if one shaving aid portion includes more than one shaving aid material (as is contemplated by the present invention), there is a likelihood that the shaving aid materials would have interacted within the shaving aid portion prior to shaving, though this is not necessarily the case in all instances.

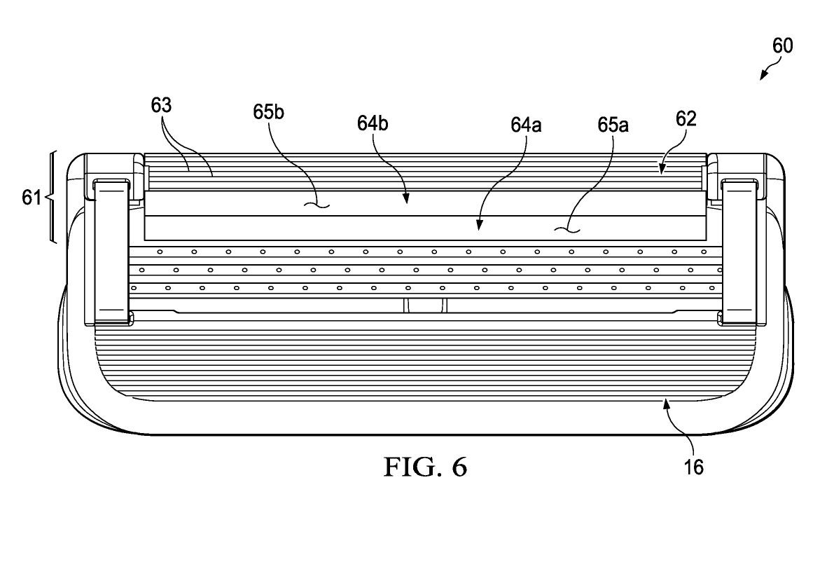

FIG. 6 depicts a razor cartridge 60 showing a cap structure 61 having two shaving aid portions 64a and 64b disposed in front of skin engaging element 62 having fin elements 63 in accordance with the present invention. Shaving aid portions 64a and 64b may be of any type as described above. For instance, shaving aid portion 64a may desirably be a lubricating strip having shaving aid material 65a while shaving aid portion 64b may desirably be foam filled with a shaving aid material 65b. Shaving aid materials 65a and 65b may of any type (e.g., as described above). For instance, shaving aid material 65a may desirably be a PEO/PS while material 65b may desirably comprise moisturizing and cleaning agents as found in soap products.

The thicknesses of skin engaging element 62 and shaving aid portions 64a or 64b (e.g., cap structure 61) are similarly ranged as described above in conjunction with FIG. 5.

The advantages of having two shaving aid portions 64 disposed in front of skin engaging element 62 are to maximize the synergy between the shaving aid portion and engaging portion and conceivably deliver different agents or chemicals having different functionality (e.g., such as moisturization, hair minimization) where such agents chemicals are generally difficult to process together without losing their unique properties.

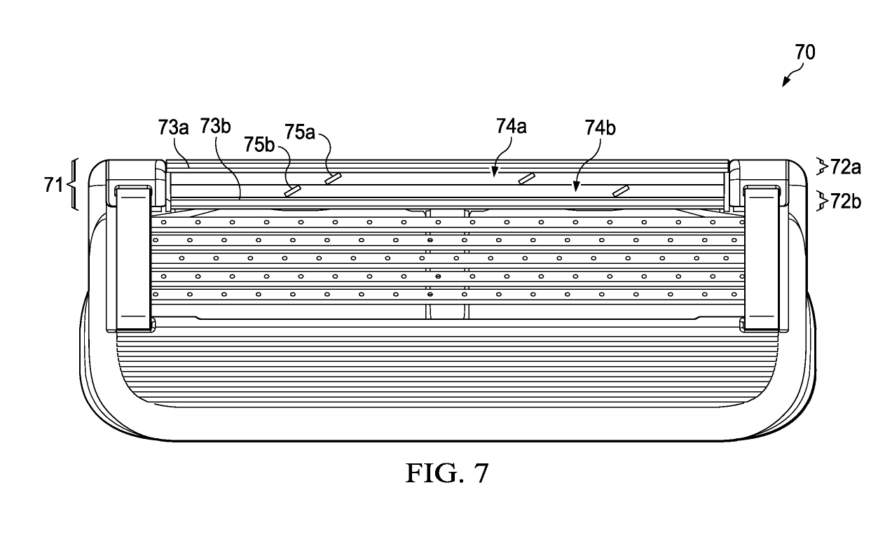

FIG. 7 depicts a razor cartridge 70 showing a cap structure 71 having two shaving aid portions 74a and 74b disposed in between skin engaging elements 72a and 72b (having fin elements 73a and 73b respectively) in accordance with the present invention. Shaving aid portions 74a and 74b may be of any type as described above. For instance, shaving aid portion 74a may desirably be a lubricating strip having shaving aid material 75a while shaving aid portion 74b may desirably be foam filled with a shaving aid material 75b. Shaving aid materials 75a and 75b may of any type (e.g., as described above). For instance, shaving aid material 75a may desirably be a PEO/PS while material 75b may desirably comprise moisturizing and cleaning agents as found in soap products.

The thicknesses of skin engaging elements 72a and 72b and shaving aid portions 74a or 74b (e.g., cap structure 71) may be in similar ranges as described above in conjunction with FIGS. 5 and 6.

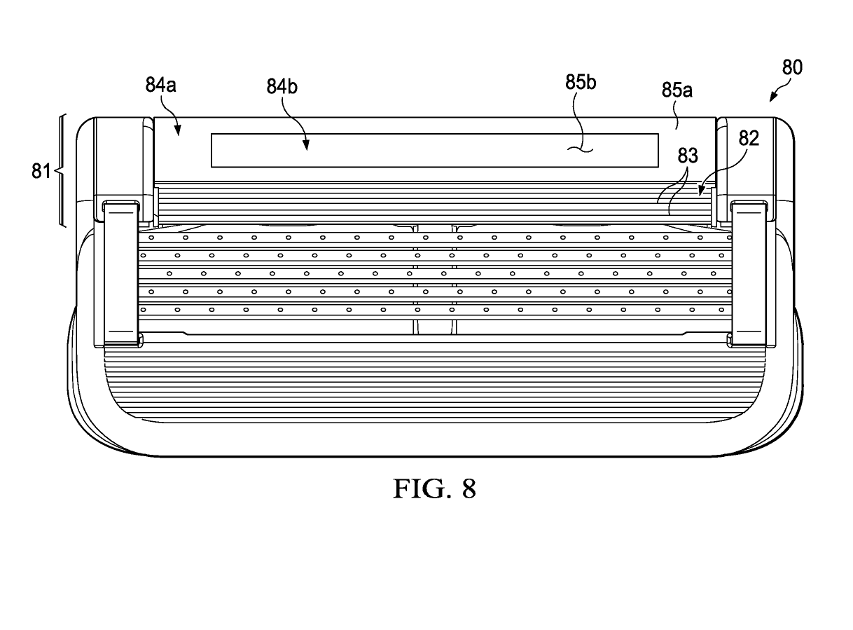

Referring now to FIG. 8, a razor cartridge 80 showing a cap structure 81 having two shaving aid portions 84a and 84b disposed in back of skin engaging element 82 having fin elements 83 in accordance with the present invention. As shown, shaving aid portions 84a is enclosed by shaving aid portion 84b or otherwise stated, shaving aid portion 84b entirely surrounds shaving aid portion 84a. Shaving aid portions 84a and 84b may be of any type. For instance, shaving aid portion 84a may desirably be a foam filled with shaving aid material 85a while shaving aid portion 84b may desirably be a lubricating strip having a shaving aid material 85b. Shaving aid materials 85a and 85b may be of any type (e.g., as described above). For instance, shaving aid material 85a may desirably be a lubricious moisturizing material while material 85b may desirably comprise a PEO/PS material having aloe or vitamin E.

The thicknesses of skin engaging elements 82a and 82b and shaving aid portions 84a or 84b (e.g., cap structure 81) may be in similar ranges as described above in conjunction with FIGS. 5-7.

The advantages of having two shaving aid portions 84a and 84b disposed in back of skin engaging element 82 are, as above, the impactful improvement in comfort and closeness sensed by the user while shaving. In addition, the arrangement of the shaving aid portions 84a and 84b in FIG. 8 may be additionally advantageous since the larger surface area provided by shaving aid portion 84b allows for more shaving aid material 85b to be dispensed and potentially interact with and/or supplement the shaving aid material 85a during shaving.

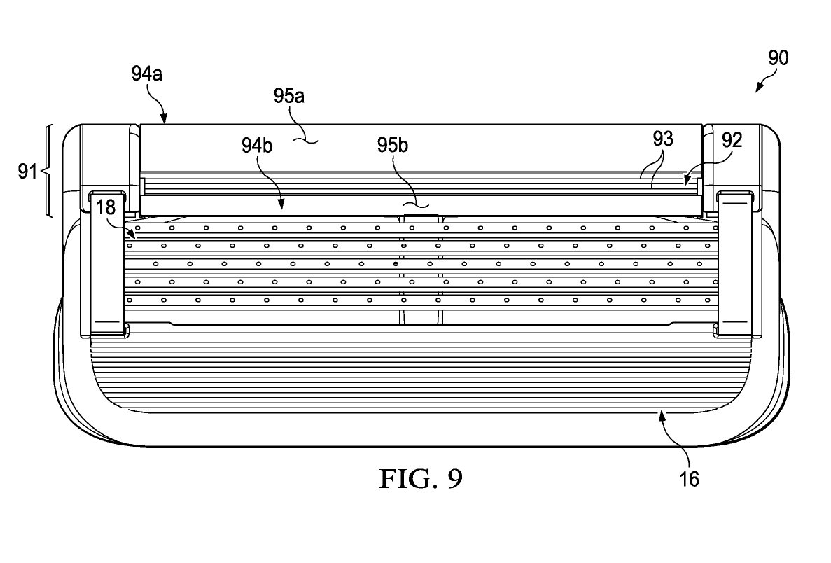

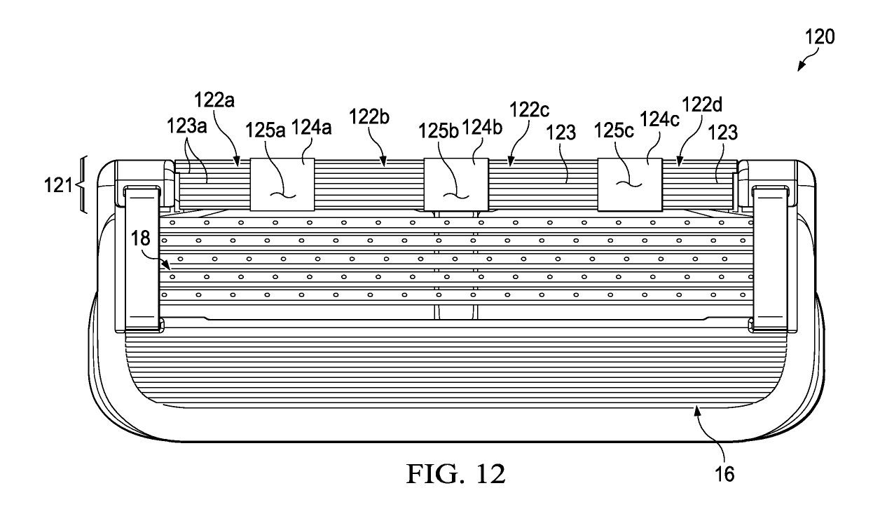

In FIG. 9, the present invention depicts a razor cartridge 90 showing a cap structure 91 having two shaving aid portions, one shaving aid portion 94a disposed in back of skin engaging element 92 having fin elements 93 in accordance with the present invention and one shaving aid portion 94b disposed in front of skin engaging element 92. Thus, FIG. 9 (as with FIG. 12 to be described below), the present invention contemplates that the shaving aid portions do not necessarily have to be adjacent to one another.

Shaving aid portions 94 and 94b may be of any type. For instance, shaving aid portion 94a may desirably be a soap wing having a shaving aid material 95a while shaving aid portion 94b may desirably be a lubricating strip having a shaving aid material 95b. Shaving aid materials 95a and 95b may be of any type (e.g., as described above). For instance, shaving aid material 95a may desirably be a lubricious moisturizing material while material 95b may desirably comprise a PEO/PS material having aloe or vitamin E.

Such an arrangement may be implemented in a cap structure for instance as found in the Gillette® Venus® Breeze™ razor cartridge products which include soap wings.

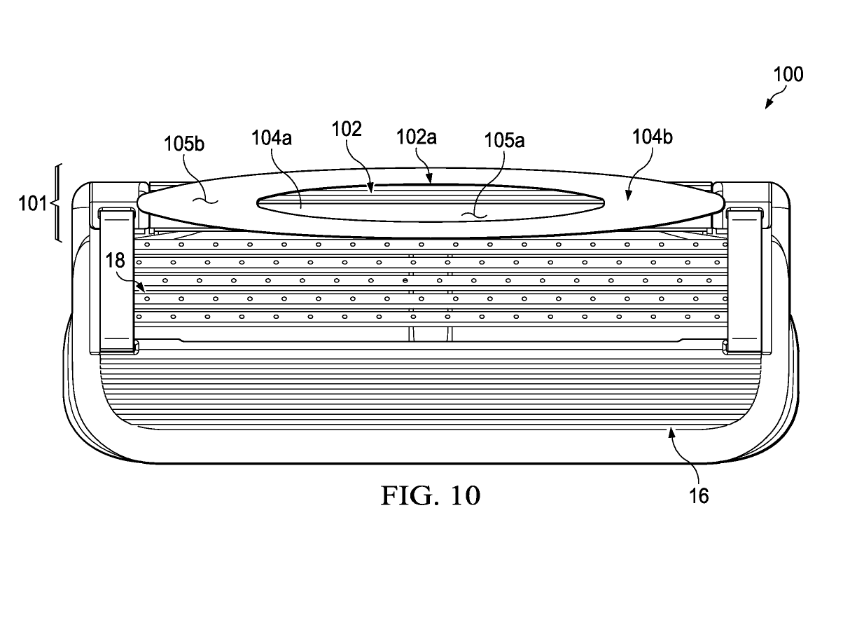

FIG. 10 depicts a razor cartridge 100 showing a cap structure 101 having two shaving aid portions, one portion 104b around an internal periphery 102a of the skin engaging element 102 and one portion 104a in front of the skin engaging element 102 but in back of portion 104b in accordance with yet another embodiment of the present invention.

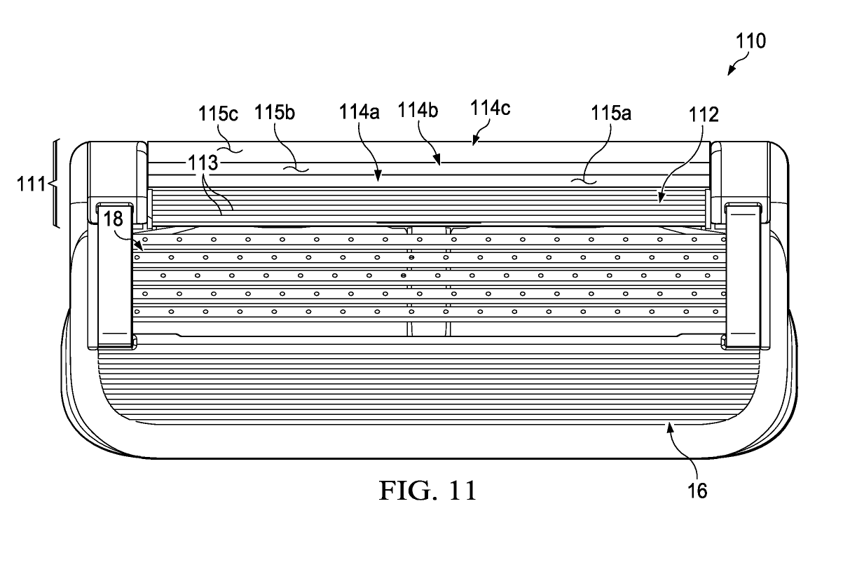

FIG. 11 depicts a razor cartridge 110 showing a cap structure 111 having three shaving aid portions 114a, 114b, 114c having shaving aid materials 115a, 115b, 115c respectively in back of skin engaging element 112 having fin elements 113 in accordance with the present invention. In the present invention, the maximum total width of all three shaving aid portions 114a, 114b, 114c may reach up to about 9 mm, and more desirably between 3 mm and 5 mm, with a maximum width of each individual shaving aid being about 3 mm and more desirably about 1 mm to about 2 mm.

FIG. 12 depicts a razor cartridge 120 showing a cap structure 121 having four skin engaging elements 122a, 122b, 122c, 122d arranged non-contiguously with each having fin elements 123a, 123b, 123c, 123d, respectively. The cap structure 121 also includes three shaving aid portions 124a, 124b, and 124c each having shaving aid material 125a, 125b, 125c respectively where shaving aid portions 124a, 124b, and 124c are disposed in between skin engaging elements 122a, 122b, 122c, 122d in accordance with the present invention. It should be noted that skin engaging elements 122a, 122b, 122c, 122d, though shown as being similarly structured with fin elements 123a, 123b, 123c, 123d, respectively, may include the same or different skin engaging element types; for instance, skin engaging element 122a and 122d may include fin elements, while skin engaging element 122b and 122c may include protrusions or nubs. Similarly, shaving aid portions 124a, 124b, 124c may each be of the same type or not. For instance, portion 124a and 124c may be a foam while portion 124b may be a lubrastrip. In addition, shaving aid materials 125a, 125b, 125c may each include the same composition or may be of a different composition.

In FIG. 12 it should be noted that the four skin engaging elements 122a, 122b, 122c, 122d, despite being arranged non-contiguously together may desirably account for greater than about 50% of the total percentage contact to the skin from the cap structure 11 and as shown in FIG. 12, potentially about 67% of the percentage contact and as such, may directly enhance shaving attributes to a user, such as shaving comfort.

Any feasible permutation of skin engaging element types, shaving aid portions and shaving aid materials is contemplated by the present invention. Some alternative embodiments are described below.

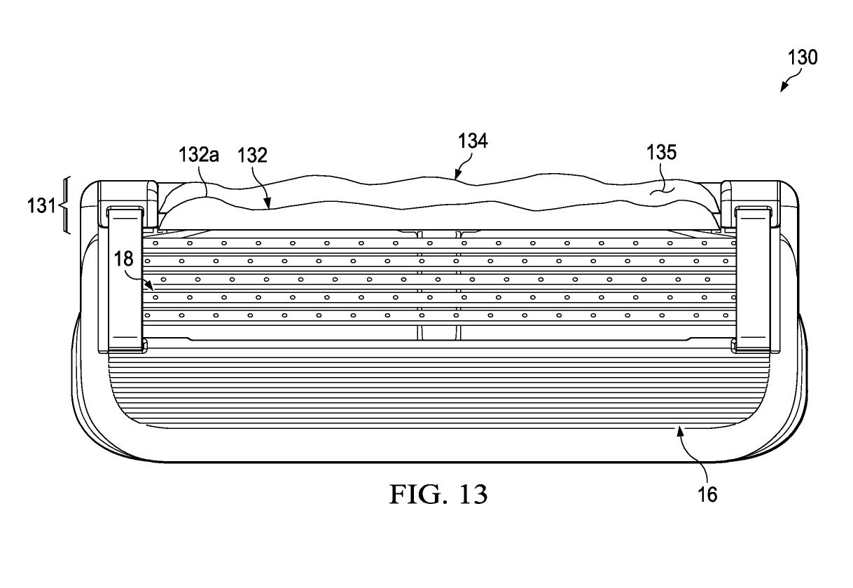

FIG. 13 depicts a razor cartridge 130 showing a cap structure 131 having one skin engaging element 132 which has a wavy construction and a shaving aid portion 134 having shaving aid material 135 in accordance with the present invention. Shaving aid portion 134 is shown also as having a wavy construction but may be of any type. Skin engaging element 132 may or may not have a planar upper surface 132a and may or may not have planar side surfaces (not shown).

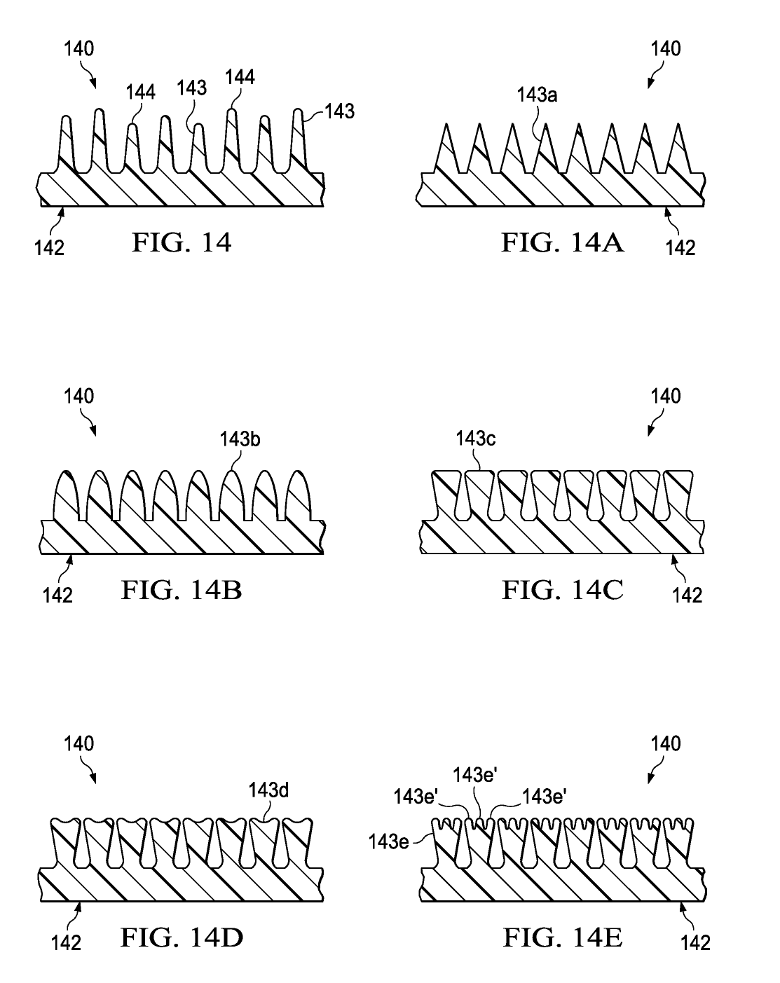

FIG. 14 depicts a portion of a razor cartridge 140 showing only a cross-section of a portion of skin engaging element 142 with fin elements 143 where fin elements are shown having non-planar upper surfaces 144 in accordance with the present invention. The fin elements 143 may each have non-planar upper surfaces or may be a mixture of planar and non-planar upper surfaces, variable or constant across the length of the skin engaging element, any such combination contemplated in the present invention.

Alternate embodiments of fin elements for skin engaging element 142 are depicted in FIG. 14A through FIG. 14E. For instance, fin elements 143a of FIG. 14A are depicted as having pointed tips or substantially triangular in shape, whereas fin elements 143b in FIG. 14B have rounded upper surfaces. In FIG. 14C, fin elements 143c are cup shaped having a wider upper surface dimension than in the lower surface and a relatively flat upper surface whereas in FIG. 14D, fin elements 143d have a slightly concave upper surface or an upper surface which curves inward. In FIG. 14E, fin elements 143e are shown as having several upper surface fingers 143e′ per each fin element 143e. These fin elements shown in FIGS. 14, 14A-14E as contemplated in the present invention are intended to be illustrative and not limiting.

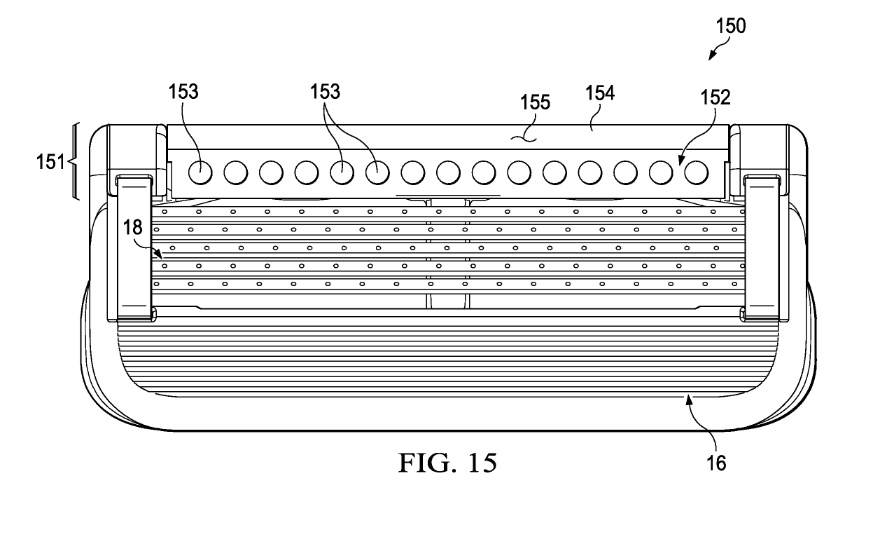

Referring now to FIG. 15, a razor cartridge 150 shows a cap structure 151 having one skin engaging element 152 with elongated protrusions 153 and a shaving aid portion 154 having at least one shaving aid material 155 in accordance with the present invention. Elongated protrusions 153 may have a diameter in the range of about 0.1 mm to about 1.0 mm and the protrusions may serve to massage skin in the area just shaved while also potentially increasing circulation to the skin surface.

The cap structure of the present invention may also be utilized in razor configurations with one or two razor blades. Many razor products include a single trimming or edging blade for smaller or difficult areas of the face (e.g., sideburns) or for creating a line or beard edge, to name a few operative uses.

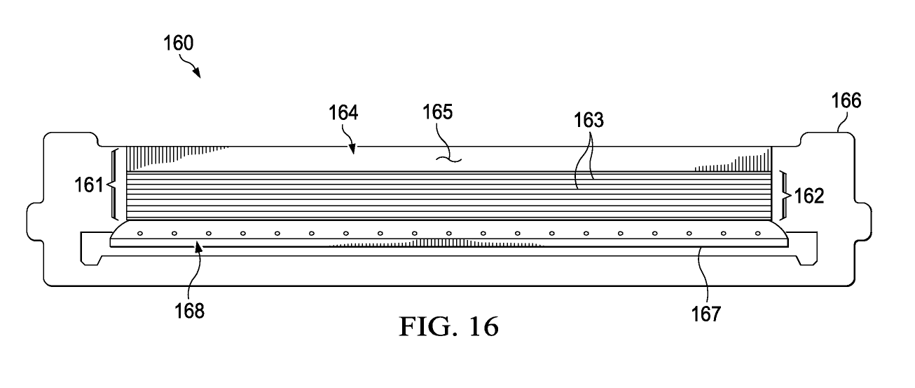

Referring now to FIG. 16, razor cartridge 160 is shown having one trimmer blade 168 disposed in a metal frame 166 and a cutting edge 167 where a cap structure 161 is disposed behind blade 168. The cap structure 161 includes a skin engaging element 162 with at least one fin element 163 and a shaving aid portion 164 having at least one shaving aid material 165 disposed behind the skin engaging element in accordance with the present invention. As described above, any arrangement of type and position of the skin engaging element and the shaving aid portion in the cap structure is contemplated by the present invention.

It should be noted that the cap structure of the present invention may have a shaving aid portion which is not directly adjacent to the skin engaging element (not shown).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
one or more blades, each of said blades having a cutting edge; and
a cap structure, disposed behind said blades and extending across a length of said cutting edges, having at least one skin engaging element and at least one shaving aid portion.

2. The razor cartridge of claim 1 wherein said at least one skin engaging element comprises at least one fin element, at least one protrusion, at least one nub, at least one wave, or any combination thereof.

3. The razor cartridge of claim 1 wherein said at least one shaving aid portion and said at least one skin engaging element are disposed in any arrangement with respect to each other.

4. The razor cartridge of claim 1 wherein said at least one shaving aid portion is disposed in back of, in front of, on the sides of, in the middle of, anywhere within, or in any combination thereof, said at least one skin engaging element.

5. The razor cartridge of claim 1 wherein said at least one shaving aid portion comprises at least one shaving aid material.

6. The razor cartridge of claim 1 wherein said at least one shaving aid portion comprises at least one foam, at least one lubricating strip, or at least one soap, or any combination thereof.

7. The razor cartridge of claim 6 wherein said at least one foam is impregnated with at least one shaving aid material.

8. The razor cartridge of claim 5 wherein said at least one shaving aid material comprises ingredients for cleaning, cooling, inhibiting the growth of hair, inhibiting the growth of microbes, inhibiting wrinkles, moisturizing, lubricating, or improving skin condition, or any combination thereof.

9. The razor cartridge of claim 1 wherein a first shaving aid portion and a second shaving aid portion are disposed in any arrangement with respect to each other and said skin engaging element.

10. The razor cartridge of claim 9 wherein said first and second shaving aid portions comprise first and second shaving aid materials.

11. The razor cartridge of claim 10 wherein ingredients of said first and second shaving aid materials interact with each other.

12. The razor cartridge of claim 1 wherein said at least one skin engaging element extends across greater than about 50% of a length of said cutting edges.

13. The razor cartridge of claim 1 wherein a percentage contact to the skin of said at least one skin engaging element is from about 20% to about 90%.

14. The razor cartridge of claim 1 wherein said at least one skin engaging element is substantially disposed in a central portion of said cap structure behind said blades.

15. The razor cartridge of claim 1 wherein said at least one skin engaging element is contiguous, non-contiguous, patterned, or any combination thereof.

16. The razor cartridge of claim 1 or 2 wherein said at least one skin engaging element further comprises polymeric, elastomeric, urethane, olefin, rubber, textile or natural materials, or any combination thereof.

17. The razor cartridge of claim 2 wherein said at least one fin element extends parallel, perpendicular, at angles, or any combination thereof, to said cutting edges of said plurality of blades.

18. The razor cartridge of claim 2 wherein said at least one fin element has an upper surface that is non-planar.

19. The razor cartridge of claim 2 wherein said at least one fin element or has a width of about 0.1 mm to about 0.25 mm, a thickness of about 0.2 mm to about 2 mm and a spacing between adjacent fins of about 0.1 mm to about 0.2 mm.

20. The razor cartridge of claim 1 wherein said at least one skin engaging element is flexible, rigid, or any combination thereof.

21. The razor cartridge of claim 2 wherein said at least one fin element is flexible.

22. The razor cartridge of claim 1 wherein said at least one skin engaging element has a width of about 0.5 mm to about 5.0 mm and a thickness of about 0.4 mm to about 2.5 mm.

23. The razor cartridge of claim 1 wherein said cap structure has a cap exposure of about −0.10 mm to about 0.2 mm.

24. The razor cartridge of claim 1 wherein there is a synergy between said at least one skin engaging element and said at least one shaving aid portion during shaving.

25. The razor cartridge of claim 2 wherein a synergy between said at least one skin engaging element and said at least one shaving aid portion comprises a trapping and releasing of shaving aid material released by said at least one shaving aid portion within said at least one fin elements of said at least one skin engaging element during shaving.

26. A method of manufacturing a razor cartridge comprising the steps of:
providing one or more blades, each of said blades having a cutting edge; and
disposing behind said blades and extending across a length of said cutting edges, a cap structure having at least one skin engaging element and at least one shaving aid portion.

27. The method of claim 26 wherein said at least one skin engaging element comprises at least one flexible fin element.

28. The method of claim 26 wherein said at least one shaving aid portion comprises at least one shaving aid material.

29. The method of claim 26 wherein a percentage contact to the skin of said at least one skin engaging element is from about 20% to about 90%.

30. The method of claim 26 wherein said cap structure has a cap exposure of about −0.10 mm to about 0.2 mm.

31. The method of claim 26 wherein a synergy between said at least one skin engaging element and said at least one shaving aid portion during shaving comprises a trapping and releasing of a shaving aid material.
